(19) United States
(12) Patent Application Publication
(10) Pub. No.: US 2017/0323269 A1
(43) Pub. Date: Nov. 9, 2017

(54) JUST-IN-TIME ONBOARDING

(71) Applicant: LinkedIn Corporation, Mountain View, CA (US)

(72) Inventors: Jason Schissel, Mountain View, CA (US); Ken Soong, Menlo Park, CA (US); Carrie Zhuqing Peng, San Jose, CA (US); Lizabeth Li, Mountain View, CA (US); Ling Lin, San Jose, CA (US); Joonhyung Lim, San Jose, CA (US); Xin Fu, Sunnyvale, CA (US); Seyedehmina Doroud, Millbrae, CA (US); Huangming Xie, Menlo Park, CA (US)

(21) Appl. No.: 15/145,469

(22) Filed: May 3, 2016

(51) Int. Cl. G06Q 10/10; G06Q 50/00; G06F 17/30

(52) U.S. Cl. CPC G06Q 10/1053; G06F 17/3053; G06Q 50/01

(57) ABSTRACT

A system determines an intent of a current user who is interacting with an online social networking system, and requests information from the current user based on the determined intent of the current user. The system then receives the requested information from the current user, and provides a service or information to the current user based on the intent of the current user and the information provided by the current user.

### TECHNICAL FIELD

The present application relates generally to data processing systems and, in one specific example, to techniques for determining the intent of a user of an online social networking system and requesting information from the user based on that intent.

### BACKGROUND

Online social network services such as LinkedIn® are becoming increasingly popular, with many such websites boasting millions of active members. Each member of the online social network service is able to upload an editable member profile page to the online social network service. The member profile page may include various information about the member, such as the member's biographical information, photographs of the member, and information describing the member's employment history, education history, skills, experience, activities, and the like. Such member profile pages of the networking website are viewable by, for example, other members of the online social network service.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 illustrates an example member profile page, according to various embodiments;

FIG. 4 illustrates relationships between the intent of a user of an online social networking system and requests for information from the user, according to various embodiments;

FIG. 5 illustrates an example of a mapping between requests for user information and opportunity index actions, according to various embodiments;

FIG. 6 illustrates the relationship between a user's intent and requested information for a user of an online social network who is searching for a job, according to various embodiments;

FIG. 7 illustrates the relationship between a user's intent and requested information for a user of an online social network who is looking to keep in touch with people and/or to build his or her network of people, according to various embodiments;

FIG. 8 illustrates the relationship between a user's intent and requested information for a user of an online social network who is looking to keep informed by finding and reading articles available on an online social networking system, according to various embodiments;

FIG. 9 is a flowchart illustrating an example method, according to various embodiments; and

FIG. 10 is a diagrammatic representation of a machine in the example form of a computer system within which a set of instructions, for causing the machine to perform any one or more of the methodologies discussed herein, may be executed.

### DETAILED DESCRIPTION

Example methods and systems for determining an intent of a user of an online social networking system and requesting information from the user based on that intent are described. In the following description, for purposes of explanation, numerous specific details are set forth in order to provide a thorough understanding of example embodiments. It will be evident, however, to one skilled in the art that the embodiments of the present disclosure may be practiced without these specific details.

According to various example embodiments, a system is configured to determine an intent of a user of an online social networking system such as LinkedIn® and to request information from the user based on that intent. Because the type of information needed is intelligently determined and requested on an as needed basis (instead of requesting a world of information when a user first becomes a member of an online social network), the system results in a reduction in the required processing power and network bandwidth demands placed on the online social networking service hardware and software infrastructure.

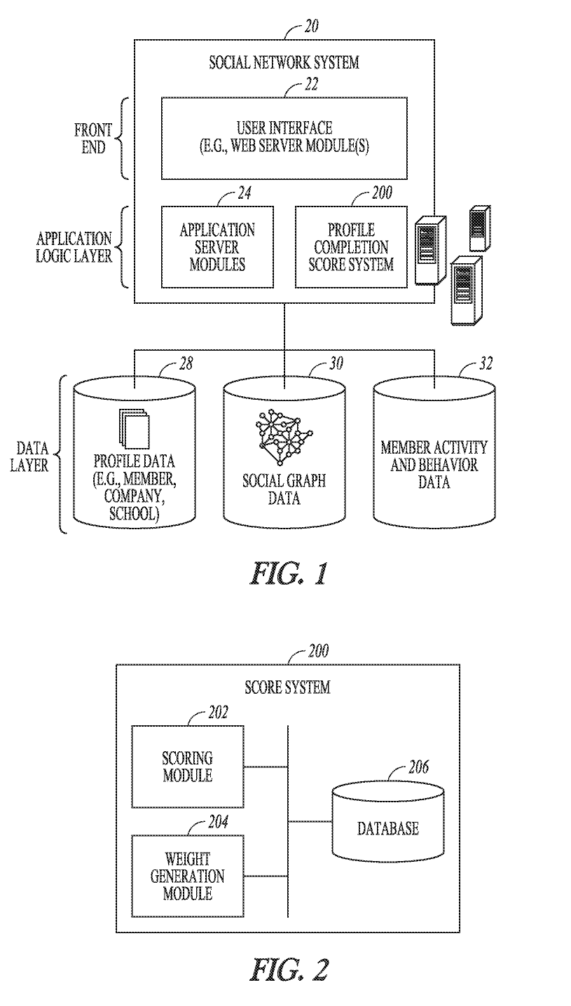

FIG. 1 is a block diagram illustrating various components, functional modules, and/or configured processors of a social network system or service such as the social network system 20, consistent with some embodiments. As shown in FIG. 1, the front end consists of a user interface module or processor (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules and/or processors 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

With some embodiments, the social network system 20 includes what is generally referred to herein as a score system 200. The score system 200 is described in more detail below in conjunction with FIG. 2.

Although not shown, with some embodiments, the social network system 20 provides an application programming interface (API) module and/or processor via which third-party applications that can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, a score system 200 includes a scoring module and/or processor 202, a weight generation module and/or processor 204, and a database 206. The modules of the score system 200 may be implemented on or executed by a single device or on separate devices interconnected via a network (e.g., one or more client machines or application servers). The operation of each of the aforementioned modules and/or processors of the score system 200 will be described in greater detail in conjunction with the various figures.

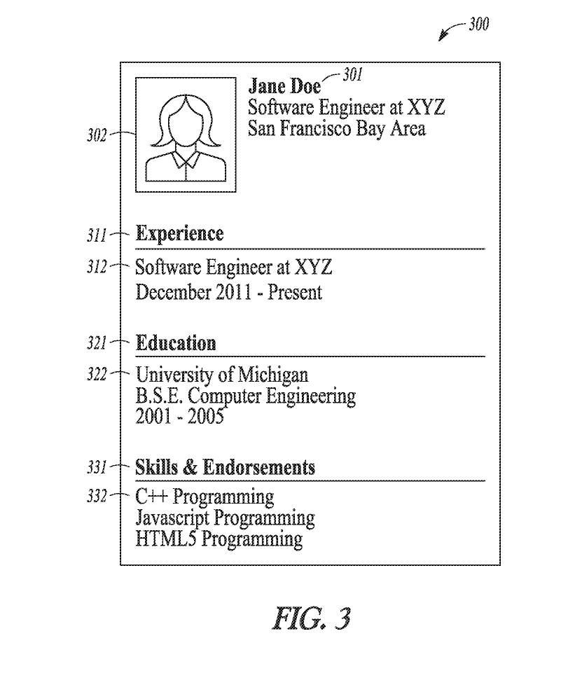

Generally, each member of an online social network service (such as LinkedIn®) has a member profile page that includes various information about that member. An example member profile page 300 of an example member “Jane Doe” is illustrated in FIG. 3. As seen in FIG. 3, the member profile page 300 includes identification information 301, such as the member's name (“Jane Doe”), member's current position, (“Computer Programmer at XYZ”), and geographic address/location information (“San Francisco Bay Area”). The member's profile page 300 also includes a photo area 302 for displaying a photograph of the member. Further, the member profile page 300 includes various sections (also known as fields). For example, member profile page 300 includes an experience section 311 including listings of past or present experience positions of the member (e.g., employment/volunteer experience position 312), an education section 321 including listings of past or present educational credentials of the member (e.g., university degree or diploma 322 earned or currently being earned by the member), and a skills & endorsements section 331 including listings of various skills of the member and endorsements of those skill listings by other members. Member profile page 300 is merely exemplary, and while the member profile page 300 includes certain sections (e.g., experience sections and education sections), these sections or fields may be supplemented or replaced by other sections or fields (e.g., a general portfolio section/field, an art portfolio section/field, a music portfolio section/field, a photography portfolio section/field, a multimedia section/field, a volunteer section/field, and so forth). A member profile page may include other information, such as various identification information (name, username, social media handle, email address, geographic address, networks, location, phone number, fax number, etc.), past or present education information, past or present employment information, past or present volunteer information, resume information, skills, endorsements, recommendations, title, industry, company size, seniority level, activities, group membership, images, photos, preferences, news, status, links or URLs on the profile page, and so forth.

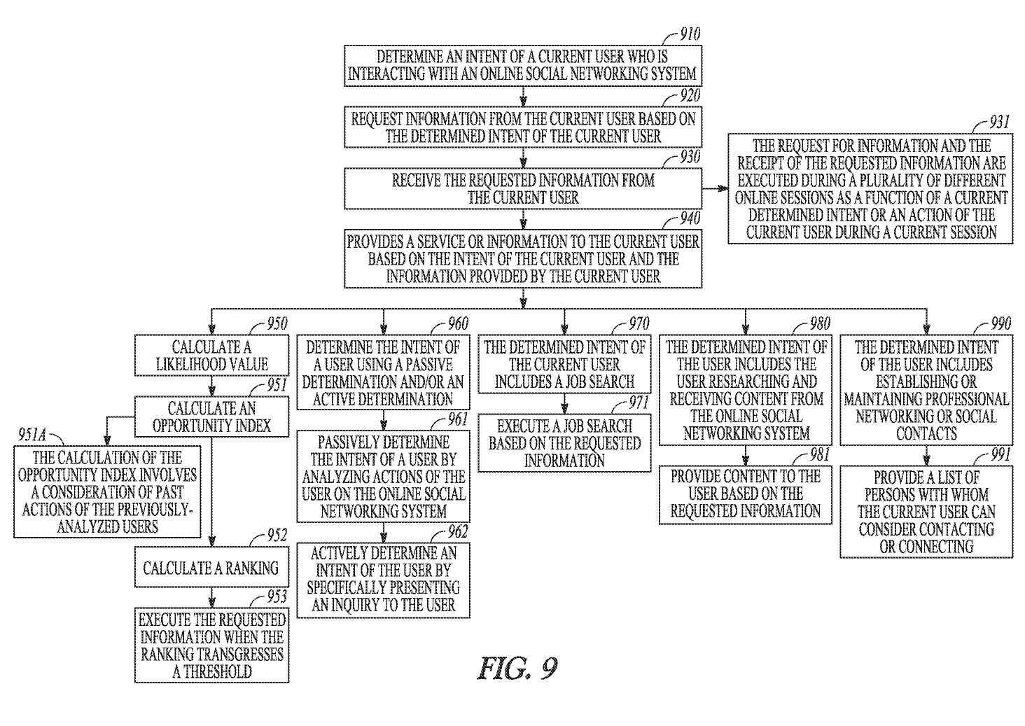

FIG. 9 is a flowchart illustrating an example method 900, consistent with various embodiments described herein. The method 900 may be performed at least in part by, for example, the score system 200 illustrated in FIG. 2 (or an apparatus having similar modules or processors, such as one or more client machines or application servers).

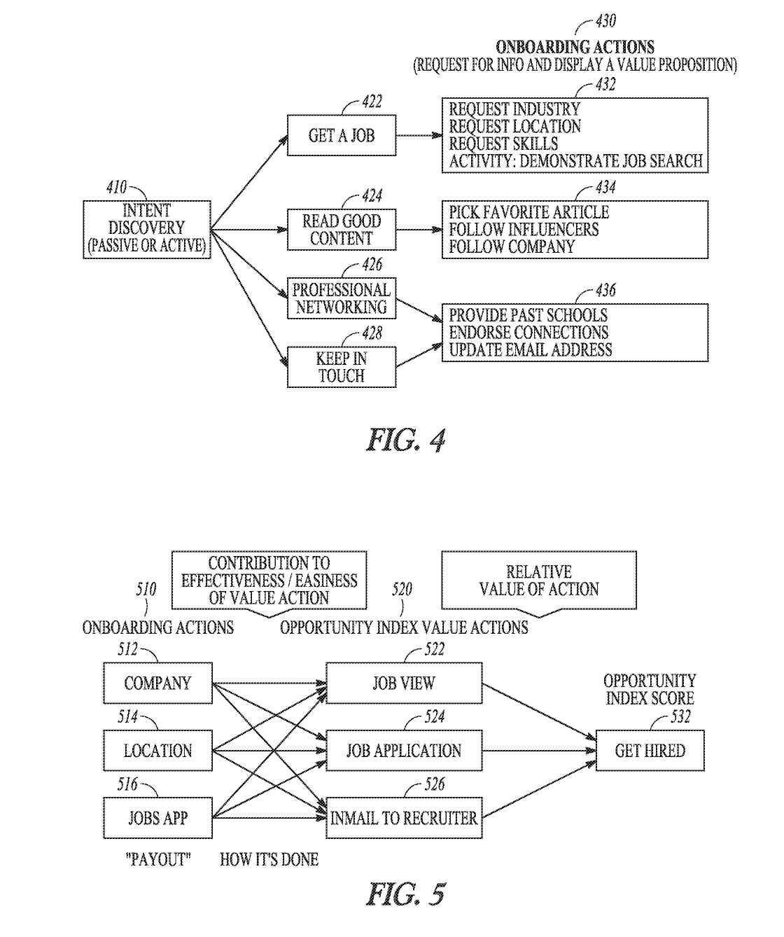

Referring specifically to FIG. 9, at 910, an online social networking system determines an intent of a current user who is interacting with the online social networking system. The determination of the intent of a user is further illustrated in FIG. 4 at 410. As discussed in more detail below, the intent of a user can be finding a job (422), reading content on the social networking system (424), professional networking (426), and/or keeping in touch with others (428). At 920, the system requests information from the current user based on the determined intent of the current user. As illustrated at 432, 434, and 436, the requested information can include many topics, such as requesting what industry the user is interested in, what companies a user would like to follow, and what schools the user has attended. These and other requested pieces of requested information are discussed in more detail below. At 930, the system receives the requested information from the current user, and at 940, the system provides a service or information to the current user based on the intent of the current user and the information provided by the current user.

As indicated at 931, the system's request for information and the system's receipt of the requested information are executed during a plurality of different online sessions as a function of a current determined intent, or as a function of an action of the current user during a current session. This request for information during different online sessions can be referred to as onboarding actions (430). In particular, since the information is requested during different sessions, and further is requested when a relevant intent is determined, the request for information can be referred to as just-in-time onboarding. Consequently, in an embodiment, the online social networking system does not attempt to gather all or every piece of information about a user when that user first becomes a member of the online social networking system. Because all the information is not requested when a user first becomes a member, the user is not initially burdened with a voluminous request for information even before the user has used the social networking system and is not entirely familiar with all the features of the online social networking system. Additionally, since the social networking system does not try to get every conceivable piece of information about the user when the user first joins, the user gets to actually navigate the system sooner, and the user is less likely to cease the registration process because of the amount of information the system is seeking. Moreover, as noted above, when the online social networking system is able to determine one or more intents of the user, either by asking the user during a subsequent session or based on actions of the user, the social networking system can then request pointed information based on the determined intent or actions of the user.

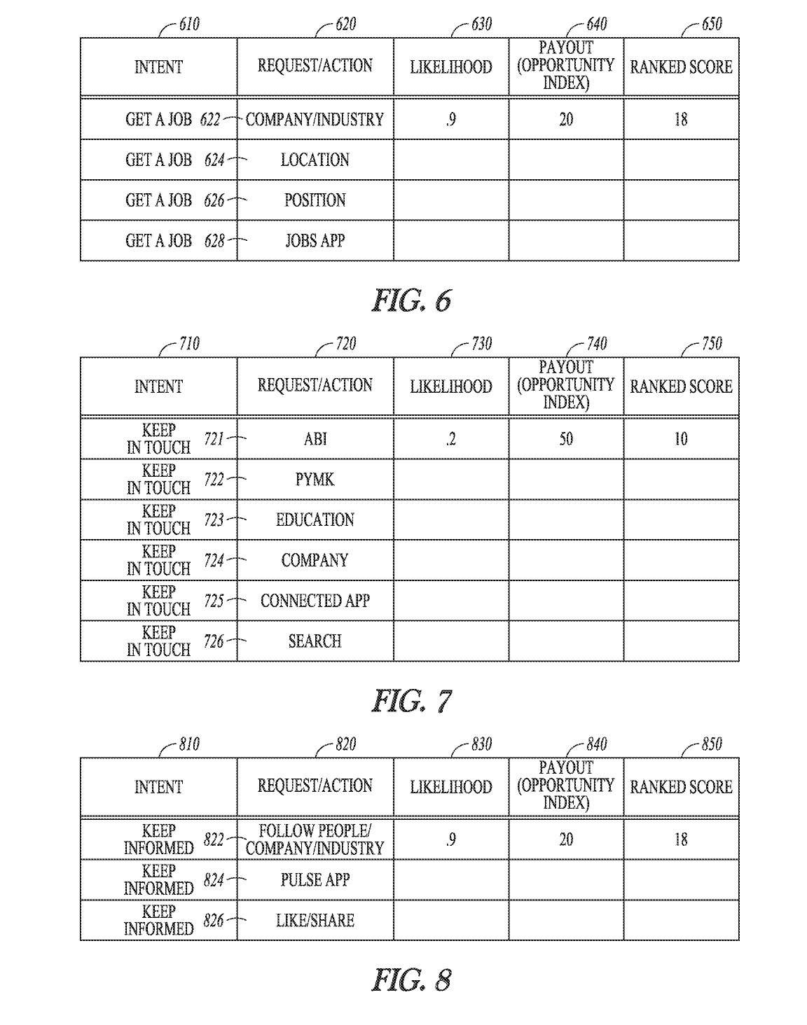

At 950, the online social networking system calculates a likelihood value. The likelihood value is illustrated at 630, 730, and 830 in FIGS. 6, 7, and 8. The calculation of the likelihood value is based on a logistic regression of previously-analyzed users who have the same intent as the current user. For example, as illustrated in FIG. 6, a logistic regression across all previously-analyzed users who are looking for a job (an action or a request 620) with a particular company or in a particular industry (622) determined that the likelihood of matched intent was 0.9. That is, based on his or her actions, the likelihood that the current user is also looking for a job is 0.9 (628). Such logistic regression can also consider the likelihood of finding a job in a particular geographic location (624) and finding a particular job position (626).

More specifically, a logistic regression performs a prediction modeling process based on users who have the same or similar intent as the current user and who have other factors in common with the current user (such as attended the same school and have worked for the same company) in order to calculate the likelihood value. According to various exemplary embodiments described in more detail below, the aforementioned modeling process may include training a model (e.g., a logistic regression model) based on the common requests/actions 620, 720, and 820. Thereafter, the trained model may analyse other users who have the same intent as the current user to predict a likelihood value 630, 730, and/or 830.

The prediction modeling module may use any one of various known modeling techniques to perform the modeling. For example, according to various exemplary embodiments, the modeling module may apply a statistics-based machine learning model such as a logistic regression model to the requested information/actions 620, 720, and 820. As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event given a set of independent/predictor variables. A highly simplified example machine learning model using logistic regression may be ln[p/(1−p)]=a+BX+e, or [p/(1−p)]=exp(a+BX+e), where In is the natural logarithm, logₑₓₚ, where exp=2.71828 . . . , p is the probability that the event Y occurs, p(Y=1), p/(1−p) is the “odds ratio”, ln[p/(1−p)] is the log odds ratio, or “logit”, a is the coefficient on the constant term, B is the regression coefficient(s) on the independent/predictor variable(s), X is the independent/predictor variable(s), and e is the error term. In some embodiments, the independent/predictor variables of the logistic regression model may be data associated with the job descriptions of job listings (where the data may be encoded into feature vectors). The regression coefficients may be estimated using maximum likelihood or learned through a supervised learning technique from the requested information/actions 620, 720, and 820. Accordingly, once the appropriate regression coefficients (e.g., B) are determined, the features included in a feature vector (e.g., data associated with a job description of a social network service) may be plugged into the logistic regression model in order to predict the probability that the event Y occurs (where the event Y may be, for example, a particular user with an intent to find a job with company XYZ will be hired by company XYZ). In other words, provided a feature vector including various requirements/actions 620, 720, and/or 820, the feature vector may be applied to a logistic regression model to determine the probability that the user will find a job with a particular company for example. Logistic regression is well understood by those skilled in the art, and will not be described in further detail herein, in order to avoid occluding various aspects of this disclosure. The modeling module may use various other modeling techniques understood by those skilled in the art. For example, other modeling techniques may include other machine learning models such as a Naïve Bayes model, a support vector machines (SVM) model, a decision trees model, and a neural network model, all of which are understood by those skilled in the art.

According to various embodiments described above, the requested information/actions 620, 720, and/or 820 may be used for the purposes of both training the model (for generating and refining a model and/or the coefficients of a model) and using the trained model (for making predictions). For example, if the modeling module is utilizing a logistic regression model (as described above), then the regression coefficients of the logistic regression model may be learned through a supervised learning technique from the requested information/actions 620, 720, and 820. Accordingly, in one embodiment, the online social networking system may operate in an off-line training mode by assembling the requested information/actions 620, 720, and 820 into feature vectors. (For the purposes of training the system, the system generally needs both positive examples of for example users with similar intent finding a job and users with similar intent not finding a job). The feature vectors may then be passed to the modeling module, in order to refine regression coefficients for the logistic regression model. For example, statistical learning based on the Stochastic Gradient Descent technique may be utilized for this task. Thereafter, once the regression coefficients are determined, the online social networking system may operate to perform online (or offline) inferences based on the trained model (including the trained model coefficients) on a feature vector representing users with similar intent. For example, according to various exemplary embodiments described herein, the online social networking system is configured to predict the likelihood that a user will find a job with a particular company, based on the requested information/actions 620, 720, and 820 received or inferred from the user compared to the contributions or weights of these data that were utilized to train the model. In some embodiments, if the probability that the user will find a job with a particular company is greater than a specific threshold (e.g., 0.5, 0.8, etc.), then the online social networking system may classify that particular job with that particular company as suitable for the user. In other embodiments, the scoring module 202 may calculate a score for the particular job at the particular company, based on the probability that the particular job listing is suitable for a recent college graduate.

According to various exemplary embodiments, the off-line process of training or retraining the model based on the requested information/actions 620, 720, and 820 may be performed periodically at regular time intervals (e.g., once a month), or may be performed at irregular time intervals, random time intervals, continuously, etc. Since information on the online social networking system may change over time, it is understood that the model itself may change over time (based on the current requested information/actions 620, 720, and 820 being used to train the model). Other information may change over time because, for example, industry practice within a field may change, or features, products and technology of the online social network service may change, and so on.

As described above, for the purposes of training the logistic regression model, the model generally requires both positive examples of for example users finding a job with a particular company, as well as negative examples of users not being hired by a particular company. The online social networking system may train the model based on the requested information/actions 620, 720, and 820. In this way, the model may be later utilized to analyse data associated with requested information/actions 620, 720, and 820, in order to determine the contributions of the values of the requested information/actions 620, 720, and 820, and to thus determine whether the given job listing is suitable for a recent college graduate.

Returning to FIG. 9, at 951, the online social networking system calculates an opportunity index. The opportunity index is illustrated at 640, 740, and 840 of FIGS. 6, 7, and 8. The calculation of the opportunity index is based on past actions of the previously-analyzed users (951A), and it measures the degree to which particular applications or features in the online social networking system connect members with opportunities. More specifically, the determination of an opportunity index involves four basic steps. First, member actions are tracked for a particular application or feature of the online social networking system during a particular time period (e.g., a week). Second, a value proposition is determined that corresponds to the tracked member actions. It is noted that an action may generate a value proposition for both the actor and the recipient. Third, an opportunity index per each value proposition is calculated for a member based on the actions that a member performed or received. Fourth, the member opportunity index is normalized for each value proposition, so that the member's score is between 0 and 100 for each value proposition.

In a social networking system, value propositions may include such things as researching and contacting people, building one's network, keeping up with one's connections, keeping informed and building knowledge, establishing and maintaining one's reputation, and getting hired by an employer. All of these value propositions have different member actions that are associated with them, and these actions have values associated with them for use in calculating the opportunity index. For example, the actions of viewing other's profiles and sending emails to others are associated with the value proposition of researching and contacting people. The action of making a new connection is associated with the value proposition of building one's network. The actions of liking or commenting on a post, sharing a post, making an endorsement or recommendation, sending a message to a connection (and in particular, a 1^{st} degree connection), and recognizing another's anniversary or birthday are associated with the value proposition of keeping up with one's connections. The action of reading an article is associated with the value proposition of keeping informed and building knowledge. The actions of having one's post getting liked or shared, receiving an endorsement or recommendation, receiving emails, and receiving views of one's profile by others are associated with the value proposition of establishing and managing one's reputation. The actions of sending an email to a recruiter, viewing job listings, and applying for a job are associated with the value proposition of getting hired by an employer.

In an embodiment, weights are assigned to each of the actions. These weights can be determined empirically based on an analysis of previous user actions. For example, such an analysis may determine that commenting on a post is more valuable to the member than making an endorsement. Consequently, the action of commenting on a post would be given a higher weight (e.g., 300) than making an endorsement (e.g., 100). Also, a full value for all value propositions for a particular time period, which is basically the sum of values of all the weights assigned to all the actions for a value proposition, are assigned. For example, the sum of the weights for all actions of the value proposition of keeping up with one's connections could be 6900. Then, for example, if a member has made two endorsements, and commented on two birthdays/anniversaries, the opportunity index for keeping up with one's connections would be as follows:

[((2*100)+2*300))/6900]*100=12

This means that the member, through his or her actions during the time period (e.g., a week) received 12% of the full value of the value proposition of keeping up with one's connections.

At 952, the online social networking system calculates a ranking. The ranking or ranked score is illustrated at 650, 750, and 850 of FIGS. 6, 7, and 8. In an embodiment, the ranking is a simple combination or multiplication of the likelihood and the opportunity index. In short, the ranking allows a member to determine the prospects of a particular request, action, or service. For example, in FIG. 6, if the user is looking for a job, and the ranked score for a particular company/industry is 18 and the ranked score for a particular geographic location is 9, the higher ranking of the company/industry indicates that more users were successful in securing a job with a particular company than securing a job in a particular location. At 953, the online social networking system executes a particular action or provides a particular service when the ranking transgresses a threshold. For example, if the threshold for a company/industry ranking is 15, and the calculated ranking is 18 as indicated at 650, then the social networking system will provide a job listing from that particular company/industry to the user who is looking for a job.

In a similar manner, for users whose intent in to keep in touch with others, a likelihood, opportunity index, and ranked score for a particular action 720 can be calculated based on an Address Book Import ABI (721), a person that the user may know (722), a person that has an educational institution or degree in common with the user (723; e.g., attended the same university), a person who worked at the same company as the user (724), a app that has connected the user and a person (725), and a search that the user has performed and that has located the person (726). For example, the calculation of the likelihood value is based on a logistic regression of previously-analyzed users who have the same intent as the current user and attended the same university as the current user. Similarly, for a user who wants to use the social networking service as a means to stay informed, a likelihood, opportunity index, and ranked score for a particular action 820 can be determined based on persons, companies, or industries that the user follows (822), a pulse app (824), and/or other members or entities with which the user has shared something (connection) or indicated a liking (826). For example, the calculation of the likelihood value is based on a logistic regression of previously-analyzed users who have the same intent as the current user and who follow the same people or companies as the current user.

Referring back to 951A, it is noted that the calculation of the opportunity index score 532 involves a consideration of past actions of the previously-analyzed users. As indicated in FIG. 5, these previous actions 520 of the previously-analyzed users can include job views 522 by the previously-analyzed users, job applications 524 submitted by the previously-analyzed users, an email 526 sent to recruiters by the previously-analyzed users, articles read by the previously-analyzed users, uses of the social networking system by the previously-analyzed users, and connections to persons at companies by the previously-analyzed users. The calculation of the opportunity index can further involve onboarding actions 510, such as requesting from the user what companies the user is interested in (512), what locations the user is interested in (514), and what job applications the user has submitted and/or job apps that the user has used (516).

At 960, and also referring to FIG. 4, the online social networking system determines the intent 410 of a user using a passive determination and/or an active determination. At 961, the online social networking system passively determines the intent of a user by analyzing actions of the user on the online social networking system. For example, if the system determines that the user is viewing and clicking on jobs in the greater San Francisco area, then the system can determine that the user is intending to find a job in the greater San Francisco area, even if the user's present geographical location is somewhere other than the greater San Francisco area. At 962, the online social networking system actively determines an intent of the user by specifically presenting an inquiry to the user. For example, the system can inquire of the user if the user is interested in searching for jobs in the greater San Francisco area.

At 970, and also referring to FIGS. 4 and 6, the determined intent of the current user includes a job search (422, 610). The information requested by the online social networking system can include a request for a particular industry in which the user is interested (432, 622), a request for a company in which the user is interested (622), a request for a job location in which the user is interested (624), a request for a job position or job title in which the user is interested (626), a request for skills of the current user (432), and a request for a completed job application from the user or the identity of a job app used by the user (628). At 971, the online social networking system executes a job search based on the requested information and the calculated ranked score 650 for each of the requested information/actions 620.

At 980, and also referring to FIGS. 4 and 8, the determined intent of the user includes the user researching and receiving content from the online social networking system (424, 810). The information requested by the user can include an identification of a favorite article, an identification of persons that the current user follows or would like to follow, or an identification of a company that the current user follows or would like to follow (434, 822). The user actions can also include use of a pulse app (for reading articles and content consumption), and can further include that the user likes a particular publication and/or has shared a particular publication with others (826). At 981, the online social networking system provides content to the user based on the requested information and the calculated ranked score 850 for each of the requested information/actions 820.

At 990, and also referring to FIGS. 4 and 7, the determined intent of the user includes establishing or maintaining professional networking or social contacts (426, 428, 436, 710). The information that is requested by the online social networking system can includes the identity of schools, colleges, and universities attended by the user (723), connections endorsed by the user (725), connections that endorsed the user (725), and an update of an email address of the current user (436). At 991, the online social networking system provides a list of persons with whom the current user can consider contacting or connecting based on the requested information and the calculated ranked score 750 for each of the requested information/actions 720.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

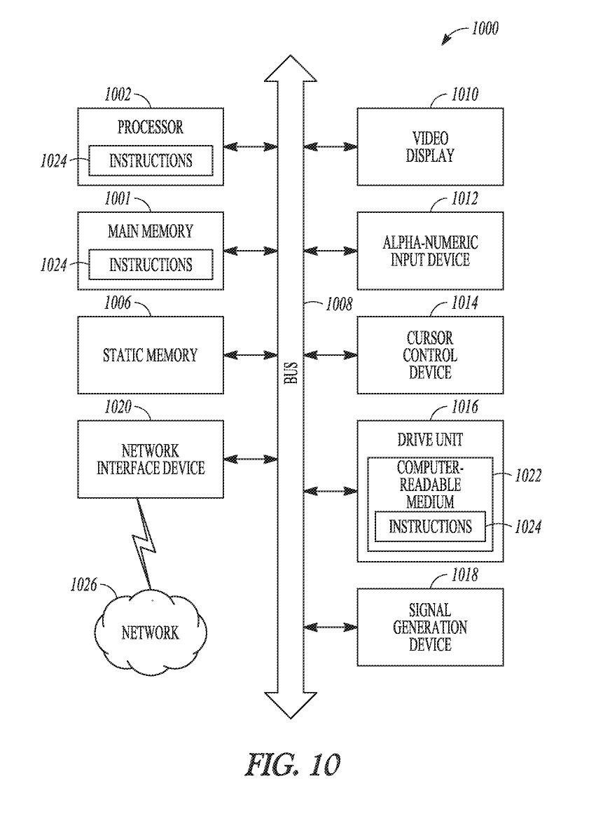

FIG. 10 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system comprising:
one or more processors; and
a computer readable medium storing instructions that, when executed by the one or more processors, cause the system to perform operations comprising:
determining an intent of a current user who is interacting with an online social networking system;
requesting information from the current user based on the determined intent of the current user;
receiving the requested information from the current user; and
providing a service or information to the current user based on the intent of the current user and the information provided by the current user.

2. The system of claim 1, wherein the requesting information and the receiving the requested information are executed during a plurality of different online sessions as a function of a current determined intent or an action of the current user during a current session.

3. The system of claim 1, comprising:
calculating a likelihood value based on a logistic regression of previously-analyzed users who have the same intent as the current user;
calculating an opportunity index based on past actions of the previously-analyzed users;
calculating a ranking based on the likelihood value and the opportunity index; and
executing the requesting information when the ranking transgresses a threshold.

4. The system of claim 3, wherein the calculation of the opportunity index involves a consideration of one or more the following past actions of the previously-analyzed users - - - a job view, a job application, an email to a recruiter, an article read by the previously-analyzed users, a use of the social networking system, and a connection to a person at a company.

5. The system of claim 1, wherein the determining an intent comprises one or more of a passive determination and an active determination.

6. The system of claim 5, wherein the passive determination comprises an analysis of actions of the current user on the online social networking system.

7. The system of claim 5, wherein the active determination comprises presenting an inquiry to the current user requesting the intent of the current user.

8. The system of claim 1, wherein the intent of the current user comprises a job search, and the requested information comprises one or more of a request for an industry, a request for a company, a request for a job location, a request for a job position or job title, a request for skills of the current user, and a request for a completed job application.

9. The system of claim 8, comprising executing a job search based on the requested information.

10. The system of claim 1, wherein the determining the intent of the current user comprises researching and receiving content from the online social networking system, and the requested information comprises an identification of a favorite article, an identification of persons that the current user follows or would like to follow, or an identification of a company that the current user follows or would like to follow.

11. The system of claim 9, comprising providing content to the current user based on the requested information.

12. The system of claim 1, wherein the intent of the current user comprises establishing or maintaining professional networking or social contacts, and the requested information comprises schools, colleges, and universities attended by the current user, connections endorsed by the current user, connections that endorsed the current user, and an update of an email address of the current user.

13. The system of claim 11, comprising providing a list of persons with whom the current user can consider contacting or connecting.

14. A method comprising:
determining an intent of a current user who is interacting with an online social networking system;
requesting information from the current user based on the determined intent of the current user;
receiving the requested information from the current user; and
providing a service or information to the current user based on the intent of the current user and the information provided by the current user.

15. The method of claim 14, wherein the requesting information and the receiving the requested information are executed during a plurality of different online sessions as a function of a current determined intent or an action of the current user during a current session.

16. The method of claim 14, comprising:
calculating a likelihood value based on a logistic regression of previously-analyzed users who have the same intent as the current user;
calculating an opportunity index based on past actions of the previously-analyzed users;
calculating a ranking based on the likelihood value and the opportunity index; and
executing the requesting information when the ranking transgresses a threshold.

17. The method of claim 16, wherein the calculation of the opportunity index involves a consideration of one or more the following past actions of the previously-analyzed users - - - a job view, a job application, an email to a recruiter, an article read by the previously-analyzed users, a use of the social networking system, and a connection to a person at a company.

18. The method of claim 14, wherein the determining an intent comprises one or more of a passive determination and an active determination;
wherein the passive determination comprises an analysis of actions of the current user on the online social networking system; and
wherein the active determination comprises presenting an inquiry to the current user requesting the intent of the current user.

19. The method of claim 14, wherein the intent of the current user comprises a job search, and the requested information comprises one or more of a request for an industry, a request for a company, a request for a job location, a request for a job position or job title, a request for skills of the current user, and a request for a completed job application; and comprising executing a job search based on the requested information.

20. The method of claim 14, wherein the determining the intent of the current user comprises researching and receiving content from the online social networking system, and the requested information comprises an identification of a favorite article, an identification of persons that the current user follows or would like to follow, or an identification of a company that the current user follows or would like to follow; and
comprising providing content to the current user based on the requested information.

21. The method of claim 14, wherein the intent of the current user comprises establishing or maintaining professional networking or social contacts, and the requested information comprises schools, colleges, and universities attended by the current user, connections endorsed by the current user, connections that endorsed the current user, and an update of an email address of the current user; and comprising providing a list of persons with whom the current user can consider contacting or connecting.
